(19) United States
(12) Patent Application Publication
(10) Pub. No.: US 2008/0273643 A1
(43) Pub. Date: Nov. 6, 2008

(54) APPARATUS AND METHOD OF EXACT TIME FRAMING IN A DMB-TH TRANSMITTER

(75) Inventors: LIN YANG, FREMONT, CA (US); HAIYUN YANG, FREMONT, CA (US); EDWARD YU, FREMONT, CA (US); JIAN WANG, FREMONT, CA (US)

Correspondence Address: FRANK F. TIAN, 331-4A THIRD AVENUE, LONG BEACH, NJ, 07740, US

(73) Assignee: LEGEND SILICON CORP., FREMONT, CA (US)

(21) Appl. No.: 11/744,828

(22) Filed: May 4, 2007

(51) Int. Cl. H04L 7/00

(52) U.S. Cl. 375/368; 375/E01.037

(57) ABSTRACT

A transmitter comprising: a digital encoder for encoding incoming digital information; and a digital to analog converter for converting the encoded digital information into analog information is described. The transmitter further comprises an exact time framing block disposed between the digital encoder and the digital to analog converter. The exact time framing block receives the digitally encoded information and comprises a method for synchronization. The method including the steps of: providing a clock signal having at least two adjacent pulses; providing information subjected to transmission in the form of a set of frames; and accommodating a whole number of frames between the two adjacent pulses.

### FIELD OF THE INVENTION

The present invention relates generally to DMB-TH transmitters, more specifically the present invention relates to an apparatus and method of exact time framing in a DMB-TH transmitter.

### BACKGROUND

Synchronization in different locations on the surface of Earth is desirable in such systems or devices associated with terrestrial communications. For example, in the newly issued Chinese Terrestoral Digital scheme (GB20600-2006), synchronization is one of the requirements. Typically, various clock devices associated with a communication system are used in various systems that require synchronization. To synchronize these clock devices poses a challenge, especially if these devices are dispersed around an extensive geographical area. Therefore, it is desirable to have a device that uses a universally accepted timing system for synchronization among communication devices dispersed around an extensive geographic area.

### SUMMARY OF THE INVENTION

A method for synchronization is provided. The method including the steps of: providing a clock signal having at least two adjacent pulses; providing information subjected to transmission in the form of a set of frames; and accommodating a whole number of frames between the two adjacent pulses such that the beginning point of the set of frames coincide with the beginning point of the first of the two adjacent pulses.

A transmitter comprising: a digital encoder for encoding incoming digital information; and a digital to analog converter for converting the encoded digital information into analog information is described. The transmitter further comprises an exact time framing block disposed between the digital encoder and the digital to analog converter. The exact time framing block receives the digitally encoded information and comprises a method for synchronization. The method including the steps of: providing a clock signal having at least two adjacent pulses; providing information subjected to transmission in the form of a set of frames; and accommodating a whole number of frames between the two adjacent pulses such that the beginning point of the set of frames coincide with the beginning point of the first of the two adjacent pulses.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an example of a transmitter in accordance with some embodiments of the invention.

FIG. 2 is an example of a frame structure in accordance with some embodiments of the invention.

FIG. 3 is an example of a global clock pulses associated with the frame structure of FIG. 2 in accordance with some embodiments of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to synchronization of frames in a transmission side using a universally accepted, global clock. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of synchronization of frames in a transmission side using a universally accepted, global clock described herein. The non-processor circuits may include, but are not limited to, a radio receiver, a radio transmitter, signal drivers, clock circuits, power source circuits, and user input devices. As such, these functions may be interpreted as steps of a method to perform synchronization of frames in a transmission side using a universally accepted, global clock. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

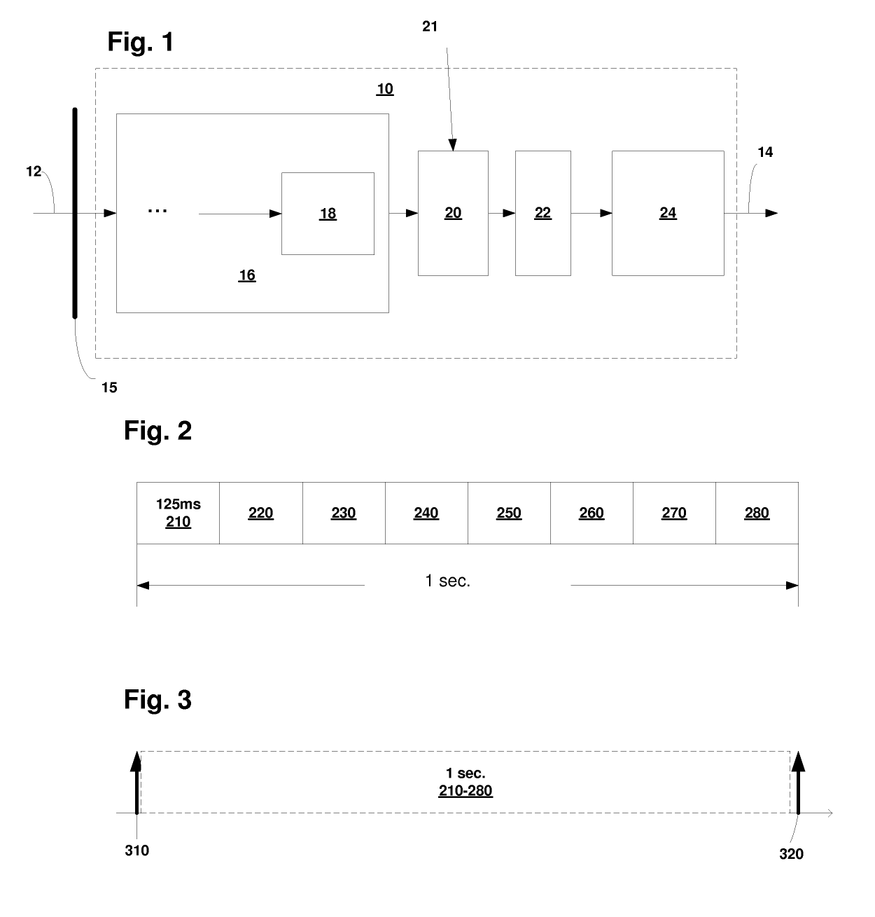

Referring to FIGS. 1-3, an apparatus and method of exact time framing in a DMB-TH transmitter are shown. In FIG. 1, a transmitter 10 is provided. 10 receives video and audio information 12 for transmission. 12 may include such frame structures as MPEG-x Transport Stream (TS), where x equals 1, 2, 4, or any suitable frame structure. 10 generates a radio frequency (RF) signal 14 suitable for wireless transformation.

Turning back to 12, which is fed into 10 by initially passing through an interface 15 wherein various types of digital signals are first identified and processed accordingly before digitally encoded by an encoder 16. 15 may include such interfaces as digital video broadcast asynchronous serial interface (DVB-ASI), or digital video broadcast synchronous parallel interface (DVB-SPI). 16 comprises a square root raised cosine (SRRC) filter 18 and various other suitable devices (not shown) for digital processing or encoding the 12 such as TS.

The encoded TS is then subjected to exact time framing block 20. In FIGS. 2-3, exact time framing 20 is shown. First, a set of frames that can be accumulated in time and be associated with a clock signal is desired. Second, the clock signal, preferably a global clock signal or sequence, which can be used for synchronization in a relatively larger geographic area, is used. Adjacent clock pulses needs accommodate or fit therebetween a whole number of frames. The exacted fitted encoded TS is then subjected to a digital to analog converter 22, the converted information is, in turn, subject to processing by the analog portion of 10.

For example, a GPS receiver (not shown) is integrated with the DMB-TH transmitter 10. The GPS receiver is adapted to feed a GPS clock signal 21 into 20, the broadcasting network may be a single frequency network (SFN), or a multi-frequency network (MFN) 10 possesses a 1 pps (pulse per second) source of GPS or possesses a global or common real time clock source.

To explain the exact time framing 20, the SRRC filter output or a point immediately before 22 is selected as the reference point. A super-frame defined in a DMB-TH system (125 ms duration) is synchronized with 1 pps/8 at the point as shown in FIGS. 2-3. In other words, a superframe is defined as a frame that mesh exactly with natural time. For example, a starting time of a superframe is a point of natural time associated with a system clock that is identical to a easily acquired timing source. That is to say: at the exact time of 1 pps/8, we send the strongest sampling of the first symbol of a super-frame at the SRRC filter output or before 22. Here the first symbol is referred as the most powerful sample of the impulse response of a symbol.

In the example herein, the SRRC filter output upsampled a digital I signal and a digital Q signal. A typical upsampling factor is 4 or more. Those digital data are respectively 28 bits or more bits in parallel, be they signed or unsigned. At 20, the sample clock is running on the frequency of symbol rate multiplied with upsampling factor. For the DMB-TH system with bandwidth 8 MHz as well as upsampling factor 4, there is 30.24 MHz clock. The clock, in turn, is synchronized with 1 pps/8 from GPS.

Enough memory is needed to buffer the SRRC filter output. In the worst case, a whole super-frame must be stored in the memory. Otherwise, less memory is needed. Therefore, the size of reserved memory is 7.56 MHz (symbol rate)*4 (upsampling factor) * 32 (bits/symbol) * 0.125 ms=120.96 Mbits=15.12 Mbytes

In a scenario of Single Frequency Network (SFN), a device synchronizes the framed RF output of all the transmitters with a global clock source. This way, the setup of SFN is simplified because any transmitter equipped with the device is synchronized without the need for any further measurement and adjustment for time-delay.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “normal,” “standard,” and terms of similar meaning should not be construed as limiting the item described to a given time period or to an item available as of a given time, but instead should be read to encompass conventional, traditional, normal, or standard technologies that may be available now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

What is claimed is:

1. A method for synchronization comprising the steps of:
providing a clock signal having at least two adjacent pulses;
providing information subjected to transmission in the form of a set of frames; and
accommodating a whole number of frames between the two adjacent pulses such that the beginning point of the set of frames coincide with the beginning point of the first of the two adjacent pulses.

2. The method of claim 1, wherein the clock signal is a GPS signal.

3. The method of claim 1, wherein the two adjacent pulses are one second apart.

4. The method of claim 1, wherein the frames comprise superframes defined in a DMB-TH system.

5. The method of claim 4, wherein each of the superframes comprises a length of 125 ms.

6. The method of claim 1, wherein the whole number of frames comprises a single frame.

7. A transmitter comprising:
a digital encoder for encoding incoming digital information;
a digital to analog converter for converting the encoded digital information into analog information; and
an exact time framing block disposed between the digital encoder and the digital to analog converter, the exact time framing block receiving the digitally encoded information and comprising a method for synchronization, the method including the steps of:
providing a clock signal having at least two adjacent pulses;
providing information subjected to transmission in the form of a set of frames; and
accommodating a whole number of frames between the two adjacent pulses.

8. The transmitter of claim 7, wherein the transmitter comprises a DMB-TH transmitter.

9. The transmitter of claim 7, wherein the clock signal is a GPS signal.

10. The transmitter of claim 7, wherein the two adjacent pulses are one second apart.

11. The transmitter of claim 7, wherein the frames comprise superframes defined in a DMB-TH system.

12. The transmitter of claim 11, wherein each of the superframes comprises a length of 125 ms.

13. The transmitter of claim 7, wherein the whole number of frames comprises a single frame.
